(19) United States
(12) Patent Application Publication
(10) Pub. No.: US 2020/0318772 A1
(43) Pub. Date: Oct. 8, 2020

(54) APPARATUS FOR CONTAINING FLUID RELEASED FROM VESSEL DURING BLEEDING OPERATION TO RELEASE PRESSURE FORMED IN THE VESSEL AND RELATED METHOD

(71) Applicant: Carbon Black Specialty Services Ltd., Lloydminster (CA)

(72) Inventor: Christopher Stephen Baron, Lloydminster (CA)

(21) Appl. No.: 16/837,263

(22) Filed: Apr. 1, 2020

Related U.S. Application Data
(60) Provisional application No. 62/828,129, filed on Apr. 2, 2019.

(51) Int. Cl. F16L 55/07; F17D 3/10

(52) U.S. Cl. CPC F16L 55/07; B67D 7/78; F17D 3/10

(57) ABSTRACT

An apparatus for containing fluid released from a vessel during a bleeding operation to release pressure formed therein comprises an enclosed receptacle defining an interior of the receptacle for receiving the fluid discharged from the vessel due to the pressure during the bleeding operation, an inlet port fluidically communicated with the receptacle interior for fluidically coupling the interior with the vessel so that the fluid released from the vessel during the bleeding operation can be guided to the interior of the receptacle, a gas pressure release valve arranged to release to an external environment of the receptacle a gaseous portion of the fluid in the interior of the receptacle received from the vessel, and a drain port for selectively releasing a liquid portion of the fluid received from the vessel.

This application claims the benefit under 35 U.S.C. 119(e) of U.S. Provisional Application Ser. No. 62/828,129 filed Apr. 2, 2019.

### FIELD OF THE INVENTION

The present invention relates generally to an apparatus for use in bleeding a vessel to release pressure formed in the vessel, and more particularly to such an apparatus comprising an enclosed receptacle to receive fluid which may be discharged from the vessel during bleeding.

### BACKGROUND

A pressurized vessel which is used to contain or convey a liquid may be bled in the substantial absence of the liquid therein to release the pressure formed therein. However, normally some residue of the liquid remains in the vessel. In one example application in the oil and gas industry, an interior of a section of oil-carrying pipeline is cleaned by inserting a cleaning device which is termed “pig” in the industry, which comprises a body and a plurality of scraping fins projecting from the body for contact with an interior wall of the pipeline. The pressure in the pipeline is utilized to displace the pig along a length of the pipeline until the pig reaches a closed valve at a downstream intermediary location in the pipeline from an insertion location of the pig into the pipeline. A section of the pipeline may then be isolated by closing a valve upstream of the downstream valve in the closed position, but prior to removing the pig from the interior of the pipeline the pressure therein is bled to the environment. Normally, in this bleeding operation a user opens an appropriate bleeding valve and covers the opened bleeding valve with a porous absorbent material so that a gas released from the vessel can pass through the material to the atmosphere while any liquid is substantially retained by the material. A bleeding operation may also be performed on a well bore where, upon bleeding the well bore, both liquid and gas may be discharged as the pressure is released to the environment.

### SUMMARY OF THE INVENTION

According to one aspect of the invention there is provided an apparatus for containing fluid released from a vessel during a bleeding operation to release pressure formed in the vessel, comprising:

an enclosed receptacle having a bottom adapted for resting on a support surface and defining an interior of the receptacle for receiving the fluid discharged from the vessel due to the pressure during the bleeding operation;

an inlet port fluidically communicated with the interior of the receptacle at a spaced height from the bottom of the receptacle for fluidically coupling the interior with the vessel upon which the bleeding operation is to be performed so that the fluid released from the vessel during the bleeding operation can be guided to the interior of the receptacle;

a first gas pressure release valve fluidically communicated with the interior of the receptacle at a spaced height from the bottom of the receptacle and arranged to release to an external environment of the receptacle a gaseous portion of the fluid in the interior of the receptacle received from the vessel; and

a drain port selectively fluidically communicated with the interior of the receptacle generally at a bottom of the receptacle for selectively releasing a liquid portion of the fluid received from the vessel.

This arrangement provides a container for collecting the fluid discharged from the vessel during bleeding. The bled fluid is collected by the container which subsequently releases a gaseous portion thereof to the environment while a liquid portion of the bled fluid is retained by the container until this can be suitably discarded.

Preferably, the first gas pressure release valve is arranged to release the gaseous portion of the fluid when a pressure of said gaseous portion is at or below a prescribed pressure value.

Preferably, the prescribed pressure value is one atmosphere.

Preferably, the apparatus further includes an auxiliary gas pressure release valve fluidically communicated with the interior of the receptacle at a spaced height from the bottom of the receptacle and arranged to release to the external environment of the receptacle the gaseous portion of the fluid received from the vessel when a pressure of the gaseous portion exceeds a prescribed threshold value.

In one arrangement, the receptacle includes a bottom wall defining the bottom of the receptacle, an opposite top wall and a peripheral side wall spanning therebetween, and the first gas pressure release valve is supported on the top wall and the auxiliary gas pressure release valve is supported on the peripheral wall at a location thereon closer to the top wall than to the bottom wall.

According to another aspect of the invention there is provided a method for bleeding a vessel used to contain a fluid in order to release pressure formed in the vessel, comprising:

providing an enclosed receptacle defining an interior for receiving the fluid discharged from the vessel due to the pressure therein during bleeding, the receptacle including a gas pressure release valve arranged to release to an external environment of the receptacle a gaseous portion of the fluid in the interior of the receptacle;

fluidically coupling the interior of the receptacle with the vessel;

after fluidically coupling the interior of the receptacle with the vessel, releasing the pressure in the vessel into the receptacle to bleed the vessel, such that the fluid discharged from the vessel during bleeding is transferred to the interior of the receptacle, and the gaseous portion of the fluid discharged during bleeding is released to the external environment through the receptacle by the gas pressure release valve thereof.

Preferably, the method further includes, after releasing the pressure in the vessel to bleed the vessel, releasing from the interior of the receptacle a liquid portion of the fluid received therein during bleeding.

### BRIEF DESCRIPTION OF THE DRAWINGS

The invention will now be described in conjunction with the accompanying drawings in which:

FIG. 1 is a perspective view of an arrangement of apparatus according to the present invention;

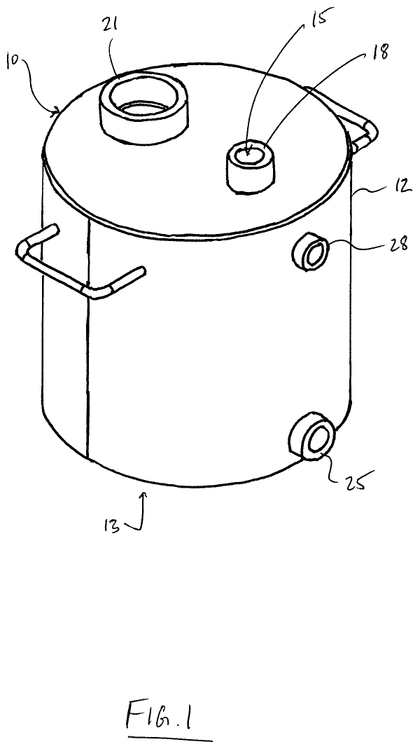

FIG. 2 is a first side view of the arrangement of FIG. 1;

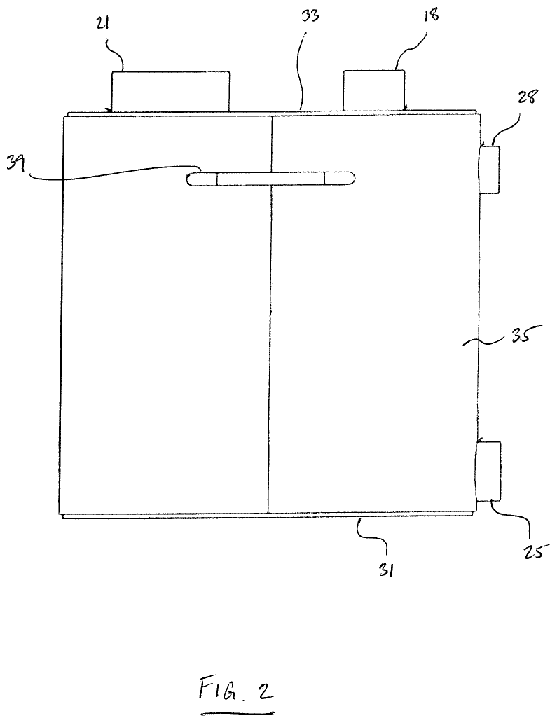

FIG. 3 is a second side view of the arrangement of FIG. 1 as viewed from a right hand side of FIG. 2; and

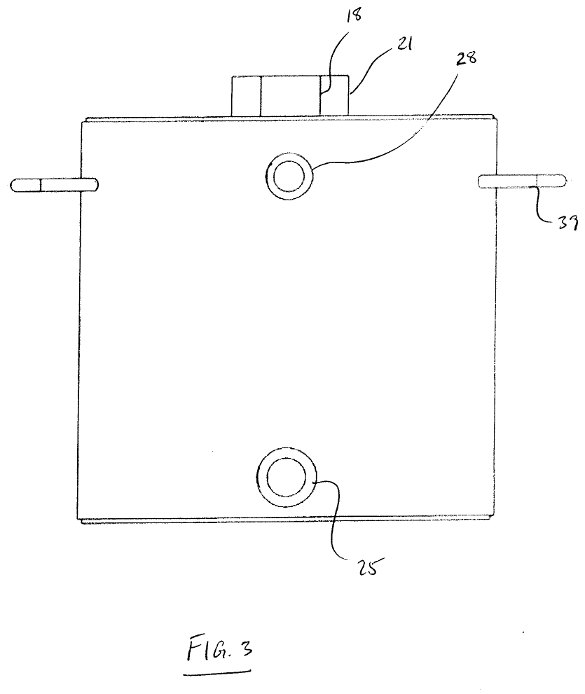

FIG. 4 is a top plan view of the arrangement of FIG. 1;

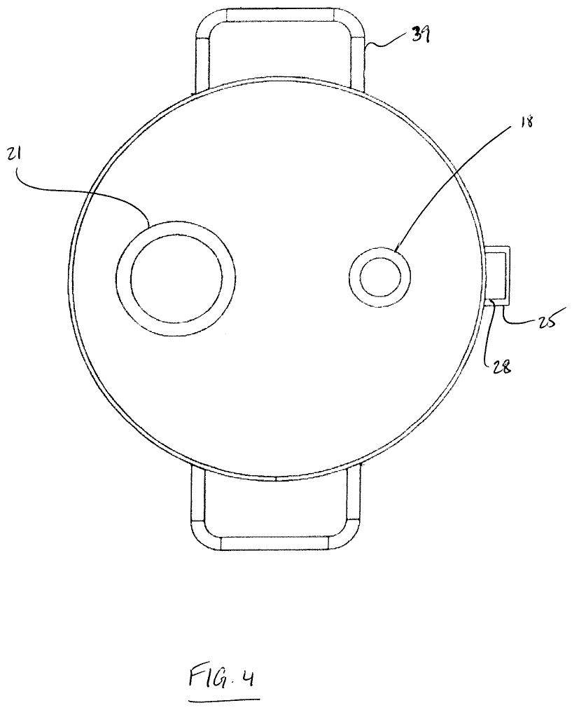

FIG. 5 is a schematic illustration of the arrangement of FIG. 1 in use during a bleeding operation to release pressure formed in a vessel.

In the drawings like characters of reference indicate corresponding parts in the different figures.

### DETAILED DESCRIPTION

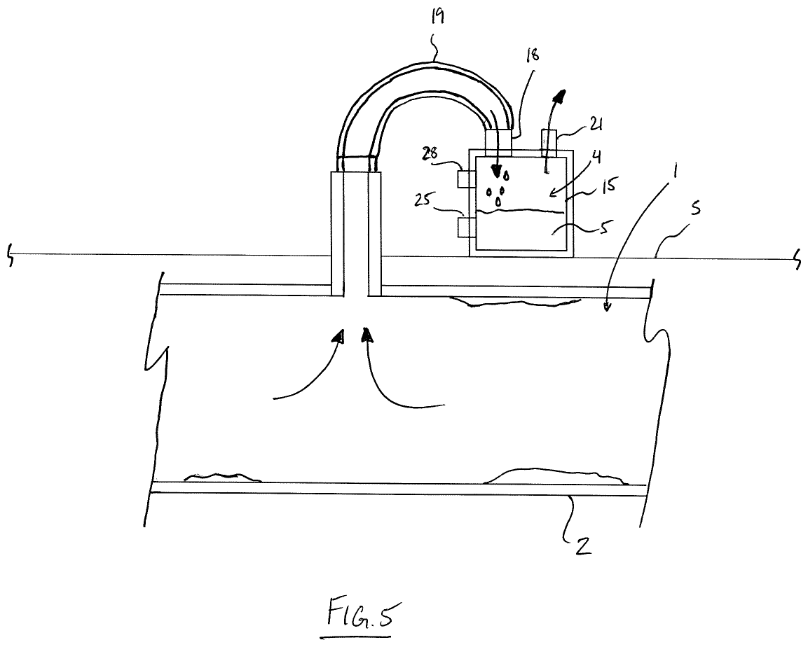

The accompanying figures show an apparatus indicated at 10 for containing fluid 1 released from a vessel 2, for example a pipeline as shown in FIG. 5 or a well bore, during a bleeding operation to release pressure formed in the vessel. The vessel 2 is generally used to contain or convey a liquid, but the bleeding operation is typically performed in the substantial absence of the liquid. However, normally some residue of the liquid remains in the vessel. Thus, the fluid 1 released from the vessel during bleeding typically includes both a gaseous portion 4 (for example air) and a liquid portion 5 (which is the remnant liquid residue in the vessel).

The apparatus 10 comprises an enclosed receptacle 12 having a bottom 13 adapted for resting on a support surface S, such as a ground surface, and defining an interior 15 of the receptacle as more clearly shown in FIG. 5 for receiving the fluid discharged from the vessel due to the pressure during the bleeding operation. The receptacle interior 15 is thus substantially closed so as to retain the fluid 1 collected therein.

The apparatus includes an inlet port 18 fluidically communicated with the interior 15 of the receptacle at a spaced height from the bottom 13 of the receptacle for fluidically coupling the interior 15 with the vessel 2 upon which the bleeding operation is to be performed so that the fluid 1 released from the vessel during the bleeding operation can be guided to the interior 15 of the receptacle. Typically, a separate fluidic conduit such as a hose 19 is provided to fluidically interconnect the receptacle interior 15 via the inlet port 18 to the vessel, and specifically an interior thereof. Preferably, the inlet port 18 is disposed generally at a top of the receptacle 12 so as not to be obstructed by the liquid portion 5 of the transferred fluid collecting in the receptacle interior 15 at a bottom thereof.

The apparatus 10 further includes a first gas pressure release valve 21 fluidically communicated with the interior 15 of the receptacle at a spaced height from the bottom 13 of the receptacle and arranged to release to an external environment of the receptacle 12 the gaseous portion 4 of the fluid 1 in the interior 15 of the receptacle received from the vessel. As such, the gaseous portion 4 of the bled fluid 1 can be released to the environment while the liquid portion 5 is retained in the receptacle interior 15 without resulting in explosion of the receptacle which has a fixed interior volume. The first gas release valve 21 also is arranged to retain the liquid portion 5 of the transferred fluid in the receptacle interior 15 so as to prevent the liquid from inadvertently escaping the receptacle since the liquid 5 may splash during the bleeding operation.

Similarly to location of the inlet 18, the first gas pressure release valve 21 preferably is disposed generally at the top of the receptacle 12 so as not to be obstructed by the liquid portion 5 of the transferred fluid collecting in the receptacle interior 15.

In the illustrated arrangement, the first gas pressure release valve 21 is arranged to release the gaseous portion 4 of the fluid when a pressure thereof is at or below a prescribed pressure value of one atmosphere which is suitable for release to the external environment. The first gas pressure release valve is a conventional arrangement of valve providing continuous yet controlled release of the gaseous portion of the transferred fluid provided that it does not exceed the prescribed pressure value. Thus the first gas pressure release valve 21 of the illustrated arrangement acts as a vent of the receptacle 12.

In order to release the retained liquid portion 5 of the transferred fluid 1, the apparatus 10 includes a drain port 25 selectively fluidically communicated with the interior 15 of the receptacle generally at the bottom 13 of the receptacle 12 for selectively releasing the liquid portion 5 of the fluid received from the vessel 2. That is, the drain port 25 is operable to be arranged a closed position in which passage of the liquid fluid portion 5 therethrough is impeded and an open position in which the passage of the liquid out of the interior 15 is permitted through the drain port 25.

In the illustrated arrangement, the apparatus further includes an auxiliary gas pressure release valve 28 fluidically communicated with the interior 15 of the receptacle at a spaced height from the bottom 13 of the receptacle and arranged to release to the external environment of the receptacle the gaseous portion 4 of the fluid received from the vessel when a pressure of the gaseous portion 4 exceeds a prescribed threshold value. This provides redundancy in case the amount of fluid 1 collected in the receptacle 12 exceeds a pressure which can be safely maintained in the receptacle interior, as the primary gas pressure release valve 21 is arranged so that only gas which is at or below the prescribed pressure value can be released therethrough to the exterior of the receptacle. Similarly to the first gas pressure release valve 21, the auxiliary gas pressure release valve is disposed generally at the top of the receptacle so as not to be obstructed by the liquid collecting therein.

In the illustrated arrangement, the receptacle 12 comprises a bottom wall 31 defining the bottom 13 of the receptacle, an opposite top wall 33 defining the top of the receptacle and a peripheral side wall 35 spanning therebetween which collectively define the closed receptacle interior 15. The first gas pressure release valve 21 is supported on the top wall 33 and the auxiliary gas pressure release valve 28 is supported on the peripheral wall 35 at a location thereon closer to the top wall 33 than to the bottom wall 31 but preferably is generally at the top so as to maximize a volume of the liquid which can be collected in the receptacle without obstructing the release of gas from the interior 15. The inlet port 18 also is supported on the top wall at a spaced location from the first gas pressure release valve 21, both of which are located at offset positions from a center of the top wall. Furthermore, the drain port 25 is supported at the peripheral wall 35.

The receptacle 12 is arranged so as to be portable so that the receptacle is movable from one location to another. A pair of handles 39 are provided on opposite locations of the peripheral wall 35 for gripping the receptacle.

In use, to bleed a vessel, which is used to contain a fluid, in order to release pressure formed in the vessel, the interior 15 of the receptacle is fluidically coupled to the vessel 2 for example via a conduit 19. Once the interiors of the receptacle and vessel are fluidically interconnected, the pressure in the vessel 2 may be released, for example by opening a bleeding valve of the vessel fluidically communicated with its interior, to bleed the vessel 2 so that the fluid 1 discharged from the vessel during bleeding is transferred to the interior 15 of the receptacle, and the gaseous portion 4 of the fluid discharged during bleeding is released to the external environment through the receptacle 12 by the gas pressure release valve 21 thereof. That is, the fluid which is released in order to bleed the vessel is guided to the interior 15 of the receptacle, where the liquid portion 5 of this fluid is retained and the gaseous portion 4 also is temporarily retained until it substantially controllably passes to the external environment through the first gas pressure release valve 21. Once the vessel has been suitably bled, the liquid portion 5 of the fluid received in the receptacle during bleeding can be released from the receptacle interior 15 via the drain port 25.

Thus is provided a container for collecting the fluid discharged from the vessel during bleeding. The bled fluid is collected by the container which subsequently releases a gaseous portion thereof to the environment while a liquid portion of the bled fluid is retained by the container until this can be suitably discarded.

The scope of the claims should not be limited by the preferred embodiments set forth in the examples but should be given the broadest interpretation consistent with the specification as a whole.

1. Apparatus for containing fluid released from a vessel during a bleeding operation to release pressure formed in the vessel, comprising:
an enclosed receptacle having a bottom adapted for resting on a support surface and defining an interior of the receptacle for receiving the fluid discharged from the vessel due to the pressure during the bleeding operation;
an inlet port fluidically communicated with the interior of the receptacle at a spaced height from the bottom of the receptacle for fluidically coupling the interior with the vessel upon which the bleeding operation is to be performed so that the fluid released from the vessel during the bleeding operation can be guided to the interior of the receptacle;
a first gas pressure release valve fluidically communicated with the interior of the receptacle at a spaced height from the bottom of the receptacle and arranged to release to an external environment of the receptacle a gaseous portion of the fluid in the interior of the receptacle received from the vessel; and
a drain port selectively fluidically communicated with the interior of the receptacle generally at a bottom of the receptacle for selectively releasing a liquid portion of the fluid received from the vessel.

2. The apparatus of claim 1 wherein the first gas pressure release valve is arranged to release the gaseous portion of the fluid when a pressure of said gaseous portion is at or below a prescribed pressure value.

3. The apparatus of claim 2 wherein the prescribed pressure value is one atmosphere.

4. The apparatus claim 2 further including an auxiliary gas pressure release valve fluidically communicated with the interior of the receptacle at a spaced height from the bottom of the receptacle and arranged to release to the external environment of the receptacle the gaseous portion of the fluid received from the vessel when a pressure of the gaseous portion exceeds a prescribed threshold value.

5. The apparatus of claim 4 wherein the receptacle includes a bottom wall defining the bottom of the receptacle, an opposite top wall and a peripheral side wall spanning therebetween, and the first gas pressure release valve is supported on the top wall and the auxiliary gas pressure release valve is supported on the peripheral wall at a location thereon closer to the top wall than to the bottom wall.

6. A method for bleeding a vessel used to contain a fluid in order to release pressure formed in the vessel, comprising:
providing an enclosed receptacle defining an interior for receiving the fluid discharged from the vessel due to the pressure therein during bleeding, the receptacle including a gas pressure release valve arranged to release to an external environment of the receptacle a gaseous portion of the fluid in the interior of the receptacle;
fluidically coupling the interior of the receptacle with the vessel;
after fluidically coupling the interior of the receptacle with the vessel, releasing the pressure in the vessel into the receptacle to bleed the vessel, such that the fluid discharged from the vessel during bleeding is transferred to the interior of the receptacle, and the gaseous portion of the fluid discharged during bleeding is released to the external environment through the receptacle by the gas pressure release valve thereof.

7. The method of claim 6 further including, after releasing the pressure in the vessel to bleed the vessel, releasing from the interior of the receptacle a liquid portion of the fluid received therein during bleeding.
